(19) United States
(12) Patent Application Publication
(10) Pub. No.: US 2013/0343315 A1
(43) Pub. Date: Dec. 26, 2013

(54) Signalling a Muting Pattern to a User Equipment for Time Domain Enhanced Inter-Cell Interference Coordination

(71) Applicants: Esa Tapani Tiirola, Kempele (FI); Kari Juhani Hooli, Oulu (FI); Jari Yrjana Hulkkonen, Oulu (FI); Kari Pekka Pajukoski, Oulu (FI)

(72) Inventors: Esa Tapani Tiirola, Kempele (FI); Kari Juhani Hooli, Oulu (FI); Jari Yrjana Hulkkonen, Oulu (FI); Kari Pekka Pajukoski, Oulu (FI)

(73) Assignee: Nokia Siemens Networks Oy, Espoo (FI)

(21) Appl. No.: 13/984,676

(22) PCT Filed: Feb. 11, 2011
(86) PCT No.: PCT/EP11/52060

§ 371 Date: Sep. 9, 2013

(51) Int. Cl. H04W 72/08

(52) U.S. Cl. CPC H04W 72/082
USPC 370/329

(57) ABSTRACT

A method for controlling radio resource usage in a communications system is described. The method includes defining in a network apparatus, a muting pattern regarding uplink signals that are to be temporarily muted, wherein said uplink signals include higher layer configured uplink signals that are outside the control of a dynamic scheduler of the network apparatus. The defined muting pattern or a part of it is signalled from the network apparatus to one or more user equipment in order to control the user equipment to mute the respective uplink signals according to the signalled muting pattern.

### FIELD OF THE INVENTION

The exemplary and non-limiting embodiments of this invention relate generally to wireless communications networks, and more particularly to controlling of radio resource usage.

### BACKGROUND ART

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context. Many network operators are evaluating the potential for deploying LTE or UMTS in a GSM band. LTE may be deployed in small spectrum bands and it enables good deployment scalability. With an improved spectrum efficiency, LTE deployment in the GSM band enables bringing higher capacity benefit and also provide operators the ability to deploy an LTE network with a greater coverage at a reduced cost compared to higher frequency spectrum.

### SUMMARY

The following presents a simplified summary in order to provide a basic understanding of some aspects of the invention. This summary is not an extensive overview of the invention. It is not intended to identify key elements of the invention or to delineate the scope of the invention. Its sole purpose is to present some concepts of the invention in a simplified form as a prelude to the more detailed description that is presented later.

Various aspects of the invention comprise a method, system, apparatus, user equipment, and computer-readable storage medium as defined in the independent claims. Further embodiments of the invention are disclosed in the dependent claims. According to an embodiment of the invention there is provided method of controlling radio resource usage in a communications system, the method comprising performing, the method steps of defining, in a network apparatus, a multi-shot or single-shot muting pattern regarding uplink signals that are to be temporarily muted, said uplink signals comprising higher layer configured uplink signals that are outside the control of a dynamic scheduler of the network apparatus; and signalling at least a part of the defined muting pattern from the network apparatus to at least one user equipment in order to control the at least one user equipment to mute said uplink signals according to the signalled pattern.

According to a further embodiment of the invention there is provided an apparatus configured to define a multi-shot or single-shot muting pattern regarding uplink signals that are to be temporarily muted, said uplink signals comprising higher layer configured uplink signals that are outside the control of a dynamic scheduler of the apparatus; and signal at least a part of the defined muting pattern to at least one user equipment in order to control the at least one user equipment to mute said uplink signals according to the signalled pattern.

According to a yet further embodiment of the invention there is provided a user equipment configured to receive, from a network apparatus, at least a part of a multi-shot or single-shot muting pattern regarding uplink signals that are to be temporarily muted, said uplink signals comprising higher layer configured uplink signals that are outside the control of a dynamic scheduler of the network apparatus; and mute higher layer configured uplink signals according to the pattern received from the network apparatus.

According to a yet further embodiment of the invention there is provided a communications system comprising an apparatus, wherein the system is configured to define, in the apparatus, a multi-shot or single-shot muting pattern regarding uplink signals that are to be temporarily muted, said uplink signals comprising higher layer configured uplink signals that are outside the control of a dynamic scheduler of the apparatus; and signal at least a part of the defined muting pattern from the apparatus to at least one user equipment in order to control the at least one user equipment to mute said uplink signals according to the signalled pattern.

According to a yet further embodiment of the invention there is provided a computer-readable storage medium embodying a program of instructions executable by a processor to perform actions directed toward defining, in a network apparatus, a multi-shot or single-shot muting pattern regarding uplink signals that are to be temporarily muted, said uplink signals comprising higher layer configured uplink signals that are outside the control of a dynamic scheduler of the network apparatus; and signalling at least a part of the defined muting pattern from the network apparatus to at least one user equipment in order to control the at least one user equipment to mute said uplink signals according to the signalled pattern.

### BRIEF DESCRIPTION OF THE DRAWINGS

In the following the invention will be described in greater detail by means of exemplary embodiments with reference to the attached drawings, in which

FIG. 1 illustrates refarming of a GSM band according to an exemplary embodiment;

FIG. 2 illustrates scheduled muting with a fixed timing relationship according to an exemplary embodiment;

FIG. 3 illustrates scheduled muting with a flexible timing relationship according to an exemplary embodiment;

FIG. 4 shows a simplified block diagram illustrating exemplary system architecture;

FIG. 5 shows a simplified block diagram illustrating exemplary apparatuses;

FIG. 6 shows a messaging diagram illustrating an exemplary messaging event according to an exemplary embodiment;

FIG. 7 shows a schematic diagram of a flow chart according to an exemplary embodiment;

FIG. 8 shows a schematic diagram of a flow chart according to another exemplary embodiment.

### DETAILED DESCRIPTION OF SOME EMBODIMENTS

Sufficient degree of flexibility is a requirement for modern communication networks. There are various use cases which require increased flexibility. These use cases include, among others, enhanced inter-cell interference coordination (eICIC), co-existence of different radio systems, providing measurement gaps for network devices (e.g. eNB, UE, relays nodes) and room for secondary communication and providing stardardized solution to avoid problems due to in-device co-existence of different radio solutions.

Refarming of radio resources refers to reassigning government-regulated electromagnetic spectrum e.g. for communication with a higher value. Users of the existing radio spectrum (e.g. GSM) are forced out, although they may be compensated in some manner. Refarmed frequency bands may be assigned e.g. to communication (e.g. LTE) that enable a greater economic or social benefit.

An exemplary embodiment relates to the evolution of LTE Release 10 (aka LTE-advanced) towards more cognitive spectrum usage. More specifically, an enhanced muting functionality for LTE uplink (UL) signals is provided. This kind of functionality is able to provide a time-domain eICIC (enhanced inter-cell interference coordination) for HetNet (heterogeneous network), and co-existence and deployment cases when refarming the GSM band with LTE. Necessary gaps for eNB/UE measurements and/or secondary communication as well as a standardized solution to avoid problems due to in-device co-existence (LTE vs. ISM/GPS radios), may be provided.

Regarding the time-domain eICIC for HetNet, LTE Rel-10 will include support for enhanced ICIC operation for heterogeneous networks (i.e. macro-femto, macro-pico). As an outcome of RAN1#62, it has been agreed to extend Rel-8/9 backhaul-based ICIC to also include a time domain component. Basically this means that coordination of almost blank sub-frames (if MBSFN is configured almost blank sub-frame does not contain CRS in the downlink data region) as well as restricting RRM/CSI measurements at the UE side is supported for a macro-pico environment.

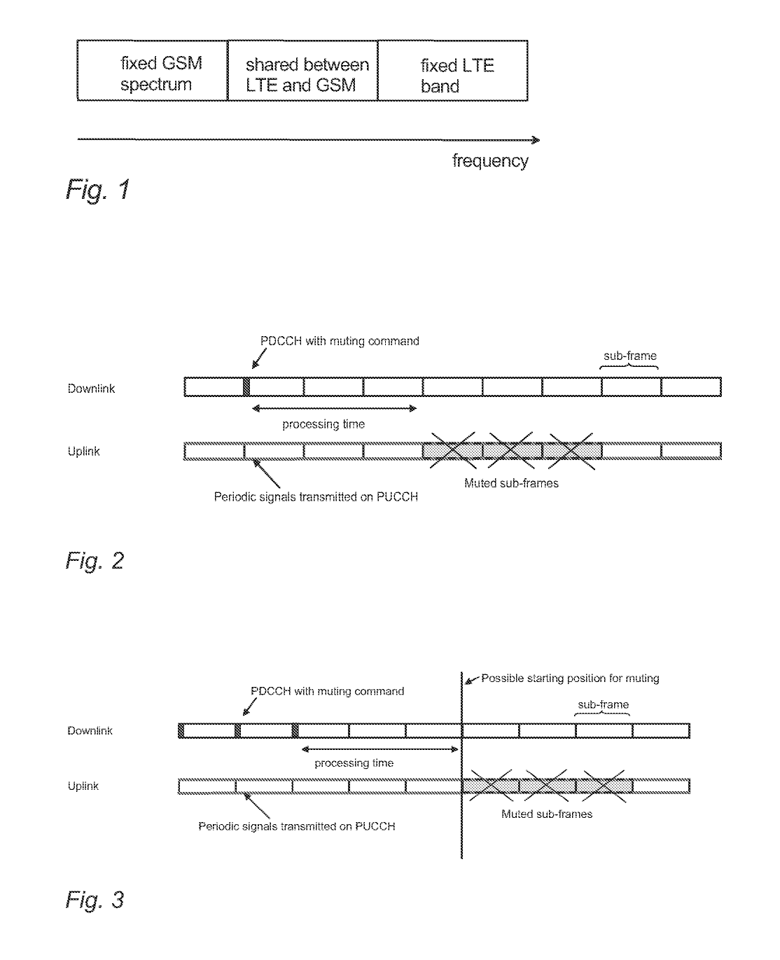

Regarding co-existence and deployment cases when LTE and GSM operate in a same band, there have been presented use cases for reconfigurable radio systems where a new radio access technology (RAT) is progressively introduced in a frequency band of a previous technology RAT. In FIG. 1, a use case is considered where a GSM band is refarmed with LTE. There are fixed spectrum allocations for both systems as well as a shared spectrum, which may be used by both systems. In an exemplary mode of operation, dynamic switching between the GSM mode and the LTE mode is supported in such a way that GSM is the primary system. LTE is allowed to operate on the shared spectrum only when its interference towards the GSM system is low enough.

An example of a channel that may require special attention in this scenario is GSM SACCH (slow associated control channel). GSM AMR voice codec is more robust than SACCH, which means that SACCH is limiting GSM voice capacity (radio link timeout mechanism drops the call when SACCH is not correctly received). Therefore, the LTE interference towards GSM SACCH is a limiting factor in the above described co-existence deployment case. Following parameters describe SACCH in time domain:
for a single user SACCH burst=0,577 ms each 120 ms at a cell level SACCH TDMA frame=4,615 ms each 120 ms

An eNB scheduler has full flexibility to make uplink free from most of the UL signals just by not scheduling any PUSCH or PDSCH, causing HARQ ACK/NACK feedback on predetermined UL sub-frames. However, dynamic scheduling is not able to temporarily mute those UL signals that are not scheduled in a dynamic manner (i.e. periodic signals, semi-statically configured signals). These signals may include: PUCCH format 1 (i.e. scheduling request) signals, persistent PUCCH format 1a/1b (i.e. persistent ACK/NACK) signals, persistent PUSCH signals, PUCCH format 2/2a/2b (periodic CQI reporting) signals, sounding reference signal signals, and/or PRACH signals. A common nominator for these signals is that they are configured by using RRC signalling and/or part of system information (MIB/SIBs).

Usage of higher layer signalling may be the only way to mute the listed UL signals. In a higher layer configuration, however, switching certain UL sub-frame off causes considerable amount of RRC signalling. Furthermore, from a delay perspective, the usage of higher layer signalling is not an acceptable solution.

In an exemplary embodiment, a method and an apparatus is provided for temporarily muting predefined UL signals (e.g. PUCCH format 1 signal, persistent ACK/NACK signal using a PUCCH format 1a/1b signal, PUCCH format 2/2a/2b signal, sounding reference signal, PRACH signal, persistent PUSCH signal) which are configured via higher layers and are outside of the dynamic control of the eNB scheduler. Thus, in an exemplary embodiment, a method and an apparatus is provided for temporarily muting predefined UL signals which are configured via higher layers and are outside of the dynamic control of an eNB scheduler. The solution may comprise three steps: defining a muting pattern, signalling the muting pattern or a part of the muting pattern from eNB to UE(s), and muting pre-defined UL signals.

An exemplary embodiment, a muting pattern is defined for signals to be temporarily muted. The muting pattern depends on the scenario (e.g. GSM refarming, eICIC). The muting pattern may be UE-specific (e.g. in-device coexistence), cell-specific (e.g. GSM refarming), network-specific (e.g. eICIC), and/or specific to a group of UEs. Muting resolution may vary depending on the application (symbol, slot, sub-frame, multiple sub-frames, half of radio frame, radio frame, etc.). Information related to the muting pattern may, if needed, be conveyed from one network node to another network node. A network element may be in charge of the defining of the muting pattern for multiple cells in these cases. The muting pattern (especially network-specific) may be coordinated among multiple cells in a certain geographical area. Coordination may be realized via standardized signalling (e.g. via X2 or OTAC) between different network nodes or via a non-standardized O&M. The muting pattern may be common for multiple cells corresponding to the same network layer (e.g. pico/femto layer).

The muting pattern or a part of the muting pattern is signalled from the network node (e.g. eNB) to one or more user equipment in the serving cell. This may involve e.g. scheduled muting, muting based on higher layer configuration signalling, and/or muting based on system information. It should be noted that defining the signals to be muted and signalling this information from the network node to UE may also be needed in certain use cases (it could be seen as a natural part of this step).

Higher layer configured uplink signals are muted at the UE side according to the signalled muting pattern received from the network node. The muting may correspond to dropping the higher-layer configured transmission according to the signalled muting pattern. The muting may also correspond to reducing transmission power for the higher-layer configured transmission according to the signalled muting pattern and according to a predefined transmission power offset. The muting may also be realized in a frequency selective manner, e.g. such that the muting is restricted on a certain frequency portion of the system bandwidth (e.g. band edges), or the muting may follow a frequency hopping pattern. The frequency hopping pattern may correspond to a frequency hopping pattern used in another RAN, e.g. in a GSM system.

The muting pattern may also be understood to refer to patterns in respect to various dimensions. For example, the muting pattern may be understood to be a pattern in respect to signals (or physical channels), frequencies (or physical resource blocks), and/or sub-frames to be muted.

An exemplary embodiment for signalling the muting pattern from the network node (eNB) to the UEs in the serving cell may involve scheduled muting. It may be based on dynamic uplink disabling signalling transmitted using PDCCH. The solution is illustrated in FIG. 2 (scheduled muting with fixed timing relationship) and FIG. 3 (scheduled muting with flexible timing relationship). It may be based on the following elements.

1) Triggering of scheduled muting is based on a special “muting PDCCH” including a cell-specific (or UE-specific, or UE group specific) identifier. The identifier, such as RNTI, may be included in PDCCH e.g. by masking for CRC. The identifier indicates that the corresponding PDCCH includes information related to muting. The identifier may be signalled to UE e.g. via higher layer signalling or as a part of system information. In order to maximize the coverage area of the muting PDCCH without increasing the number of PDCCH blind decoding at UE, it makes sense to utilize one of the smallest PDCCH payload size options, for example, a DCI format 1C (and/or 0/1A) matching the size of the “muting PDCCH” with other DCI formats may be considered as well, for the “muting PDCCH”.

2) The actual muting pattern (including the duration of the muting) may be defined via higher layer signalling (either dedicated RRC signalling or broadcast signalling). Another choice is to define the muting pattern by means of the payload bits of the “muting PDCCH” (there are roughly 25 bits available for this information).

3) It may be possible to pre-define a certain maximum processing time for UE (e.g. x sub-frames) after which the muting command becomes valid (see FIG. 2). In an exemplary embodiment, x may be set to 4.

4) It may be possible to define scheduling in such a way that that there is a fixed timing relationship between the received “muting PDCCH” and the actual muting taking place at UE. This is assumed in FIG. 2.

5) Another choice is to define possible starting positions for the muting via higher layers, either dedicated RRC signalling or broadcast signalling (e.g. system frame number). The possible starting positions may be also predetermined e.g. in a standard (for example, the start of a next radio frame). This choice allows increasing the reliability for the “muting PDCCH” since the same dynamic signalling may be repeated on multiple sub-frames before the start of muting (see FIG. 3).

An exemplary embodiment for signalling the muting pattern from the network node (eNB) to the UEs in the serving cell may involve uplink muting based on new configuration signalling. This solution may be based on modified (RRC based) configuration signalling for a corresponding signalling type (e.g. SR or PUCCH format 2/2a/2b). The additional signalling may be needed to introduce the muting pattern on top of the existing time-domain configuration of periodic signalling (i.e. which of the transmissions needs to be muted). On the other hand, it may be possible to define a separate muting pattern which is used as a “mask” for the existing signalling. In that case, muting may be triggered e.g. by means of a logical AND operation between two muting patterns.

An exemplary embodiment for signalling the muting pattern from the network node (eNB) to the UEs in the serving cell may involve uplink muting based on MBSFN signalling. In this solution, higher layer configured uplink signals may be muted based on signalled MBSFN sub-frames. The muted uplink subframes are linked to MBSFN sub-frames with a predefined time offset; e.g an UL sub-frame may be muted x sub-frames after a MBSFN sub-frame with x=4 in an exemplary embodiment. This muting method may be enabled/disabled via higher layer signalling via either dedicated RRC signalling or system information.

An exemplary embodiment for signalling the muting pattern from the network node (eNB) to the UEs in the serving cell may involve uplink muting based on new broadcast signalling only. It may be possible to signal the pre-defined muting pattern as a part of broadcast signalling. It may support PRACH muting also for UEs in an idle mode.

An exemplary embodiment for signalling the muting pattern from the network node (eNB) to the UEs in the serving cell may involve muting via transmission power reduction. Typically, muting corresponds to dropping the higher-layer configured transmission, but it may also correspond to reducing transmission power according to muting pattern and a transmission power offset. This offset may be predefined e.g. in standards, or it may be higher layer signalled via either a dedicated RRC signalling or system information, or via PDCCH. Signalling may also include an indicator for the type of muting, i.e. dropping, transmission power reduction/limitation or reduction/limitation of the power spectral density of transmission power. The signalling may be cell-specific or UE-specific. For example, in the latter case, the cell-specific muting type may be set to transmission dropping but with UE-specific signalling this setting may be altered to transmission power reduction for selected, nearby UEs.

In an exemplary embodiment, a generic and flexible solution applicable to all UL muting scenarios may be provided. A more flexible controlling of the usage of radio resources may thus be provided. A time domain eICIC for HetNet, co-existence and deployment cases when refarming GSM band with LTE, and/or in-device coexistence may be provided. Necessary measurement gaps may be provided. The proposed signalling solution may be fully compatible with LTE Rel-8/9/10. The proposed signalling is capable of muting all UL signals outside of the dynamic eNB scheduler control.

It may be difficult to support uplink muting with legacy terminals. However, in an exemplary embodiment, it may possible to allocate periodic signals for legacy UEs only for the subframes where the uplink muting is not needed.

Exemplary embodiments of the present invention will now be de-scribed more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

The present invention is applicable to any user terminal, server, corresponding component, and/or to any communication system or any combination of different communication systems that support access network discovery and selection function. The communication system may be a fixed communication system or a wireless communication system or a communication system utilizing both fixed networks and wireless networks. The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, the embodiment.

In the following, different embodiments will be described using, as an example of a system architecture whereto the embodiments may be applied, without restricting the embodiment to such an architecture, however.

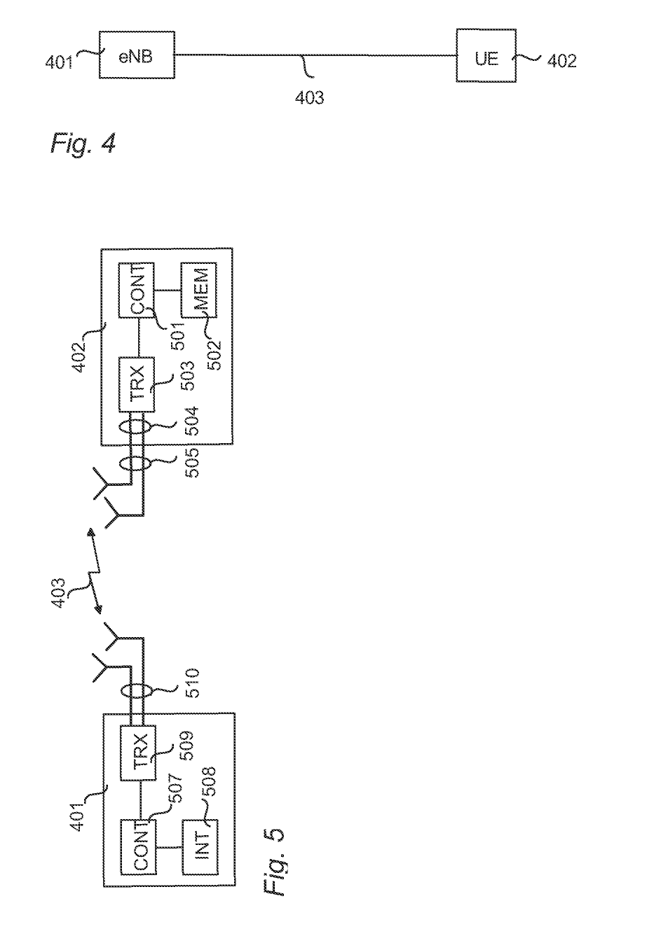

With reference to FIG. 4, let us examine an example of a radio system to which embodiments of the invention can be applied. In this example, the radio system is based on LTE network elements. However, the invention described in these examples is not limited to the LTE radio systems but can also be implemented in other radio systems, such as UMTS, GSM, EDGE, WCDMA, bluetooth network, WLAN or other mobile or wireless network. In an embodiment, the presented solution may be applied between user equipment belonging to different but compatible systems such as LTE and UMTS.

A general architecture of a communication system is illustrated in FIG. 4. FIG. 4 is a simplified system architecture only showing some elements and functional entities, all being logical units whose implementation may differ from what is shown. The connections shown in FIG. 4 are logical connections; the actual physical connections may be different. It is apparent to a person skilled in the art that the systems also comprise other functions and structures. It should be appreciated that the functions, structures, elements, and protocols used in or for wireless communication are irrelevant to the actual invention. Therefore, they need not be discussed in more detail here.

The exemplary radio system of FIG. 4 comprises a network apparatus 401 of a network operator. The network apparatus 401 may include e.g. a base station (node B, eNB) 401, access point (AP), radio network controller (RNC), MSC server (MSS), serving GPRS support node, mobility management entity (MME), home location register (HLR), home subscriber server (HSS), visitor location register (VLR) or any other network element or a combination of network elements. FIG. 4 shows a user equipment 402 located in the service area of the base station 401. The base station 401 may be connected to the user equipment e.g. via a connection 403. The user equipment refers to a portable computing device, and it may also be referred to as a user terminal. Such computing devices include wireless mobile communication devices operating with or without a subscriber identification module (SIM), including, but not limited to, the following types of devices: mobile phone, smartphone, personal digital assistant (PDA), handset, laptop computer. In the example situation of The base station 401 and the user equipment 402 are capable of connecting to each other via an access network via the connection 403.

FIG. 4 only illustrates a simplified example. In practice, the net-work may include more base stations and user terminals, and more cells may be formed by the base stations. The networks of two or more operators may overlap, the sizes and form of the cells may vary from what is depicted in FIG. 4, etc. The communication system may also be able to communicate with other networks, such as a public switched telephone network. The embodiments are not, however, restricted to the network given above as an example, but a person skilled in the art may apply the solution to other communication networks provided with the necessary properties. For example, the connections between different network elements may be realized with internet protocol (IP) connections.

FIG. 5 illustrates examples of apparatuses according to embodiments of the invention. FIG. 5 shows a user equipment 402 located in the area of the base station or eNB 401. The user equipment is configured to be in connection with the base station 401. The user equipment or UE 402 comprises a controller 501 operationally connected to a memory 502 and a transceiver 503. The controller 501 controls the operation of the user equipment 402. The memory 502 is configured to store software and data. The transceiver 503 is configured to set up and maintain a wireless connection to the base station 401. The transceiver may be operationally connected to a set of antenna ports 504 connected to an antenna arrangement 505. The antenna arrangement 505 may comprise a set of antennas. The number of antennas may be one to four, for example. The number of antennas is not limited to any particular number. The user equipment 402 may also comprise various other components, such as a user interface, camera, and media player. They are not displayed in the figure due to simplicity. The base station or eNB 401 comprises a controller 507 operationally connected to an interface 508 and a transceiver 509. The controller 507 controls the operation of the base station 501. The interface 508 is configured to setup and maintain the connection with a further network element (not shown). The transceiver 509 is configured to set up and maintain a wireless connection to the user equipment 402 within the service area of the base station 401. The transceiver 509 may be operationally connected to an antenna arrangement 510. The antenna arrangement may comprise a set of antennas. The number of antennas may be two to four, for example. The number of antennas is not limited to any particular number. The base station may be operationally connected (directly or indirectly) to a further network element (not shown) of the communication system. The further network element may be a radio network controller MSC server (MSS), serving GPRS support node, mobility management entity (MME), home location register (HLR), home subscriber server (HSS), visitor location register (VLR), a radio network controller (RNC), a gateway, or a server, for example.

The embodiments are not, however, restricted to the network given above as an example, but a person skilled in the art may apply the solution to other communication networks provided with the necessary properties. For example, the connections between different network elements may be realized with internet protocol (IP) connections.

The memory may include volatile and/or non-volatile memory and typically stores content, data, or the like. For example, the memory may store computer program code such as software applications (for example for the detector unit and/or for the adjuster unit) or operating systems, information, data, content, or the like for the processor to perform steps associated with operation of the apparatus in accordance with embodiments. The memory may be, for example, random access memory (RAM), a hard drive, or other fixed data memory or storage device. Further, the memory, or part of it, may be removable memory detachably connected to the apparatus.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firm-ware or software, implementation can be through modules (e.g., procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

User equipment may refer to any user communication device. A term “user equipment” as used herein may refer to any device having a communication capability, such as a wireless mobile terminal, a PDA, a smart phone, a personal computer (PC), a laptop computer, a desktop computer, etc. For example, the wireless communication terminal may be an UMTS or GSM/EDGE smart mobile terminal. Thus, the application capabilities of the device according to various embodiments of the invention may include native applications available in the terminal, or subsequently installed applications. The messaging service center may be implemented in any network element, such as a server.

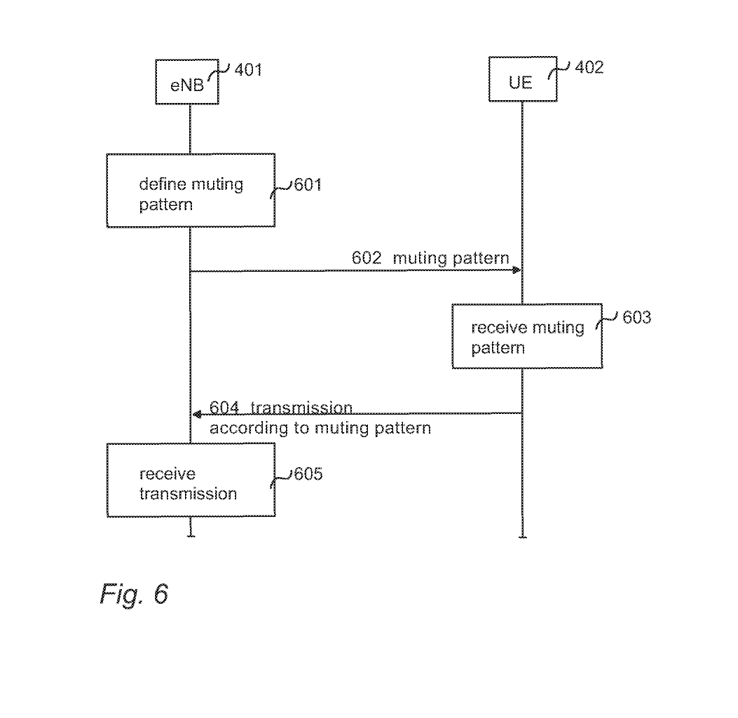

FIG. 5 is a block diagram of an apparatus according to an embodiment of the invention. Although the apparatus has been depicted as one entity, different modules and memory may be implemented in one or more physical or logical entities. The functionality of the network element 401 is described in more detail below with FIGS. 6 to 8. It should be appreciated that the apparatus 401 may comprise other units used in or for access network selection. However, they are irrelevant to the actual invention and, therefore, they need not to be discussed in more detail here.

The apparatus may also be a user terminal which is a piece of equipment or a device that associates, or is arranged to associate, the user terminal and its user with a subscription and allows a user to interact with a communications system. The user terminal presents information to the user and allows the user to input information. In other words, the user terminal may be any terminal capable of receiving information from and/or transmitting in-formation to the network, connectable to the network wirelessly or via a fixed connection. Examples of the user terminal include a personal computer, a game console, a laptop (a notebook), a personal digital assistant, a mobile station (mobile phone), and a line telephone.

The apparatus 401 may generally include a processor, controller, control unit or the like connected to a memory and to various interfaces of the apparatus. Generally the processor is a central processing unit, but the processor may be an additional operation processor. The processor may comprise a computer processor, application-specific integrated circuit (ASIC), field-programmable gate array (FPGA), and/or other hardware components that have been programmed in such a way to carry out one or more functions of an embodiment.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firm-ware or software, implementation can be through modules (e.g., procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

The signaling chart of FIG. 6 illustrates the required signalling. In the example of FIG. 6, a network apparatus 401, which may comprise e.g. a base station (eNB), defines, in 601, a multi-shot or single-shot muting pattern regarding up-link signals that are to be temporarily muted, such that the uplink signals comprise higher layer configured uplink signals that are outside the control of a dynamic scheduler of the network apparatus. The apparatus is configured to control one or more user terminals 402 to mute said uplink signals according to said muting pattern, by signalling 602 the defined muting pattern (or at least a part of the muting pattern) to the user equipment 402 (user terminal, UE). In 603, the user terminal 402 receives the muting pattern from the apparatus 401 and applies the muting pattern by muting higher layer configured uplink signals that are outside the control of a dynamic scheduler of the network apparatus, according to the muting pattern (or the part of the muting pattern) received from the network apparatus. Thus the user equipment 402 is configured to transmit 604, to the apparatus 401, signalling where selected higher layer configured uplink signals have been muted by the user equipment 402 according to (the part of) the muting pattern received from the apparatus 401. In 605, the apparatus 401 is configured to receive, from the user equipment 402, signalling where selected higher layer configured uplink signals have been muted by the user equipment 402 according to the muting pattern transmitted by the apparatus 401.

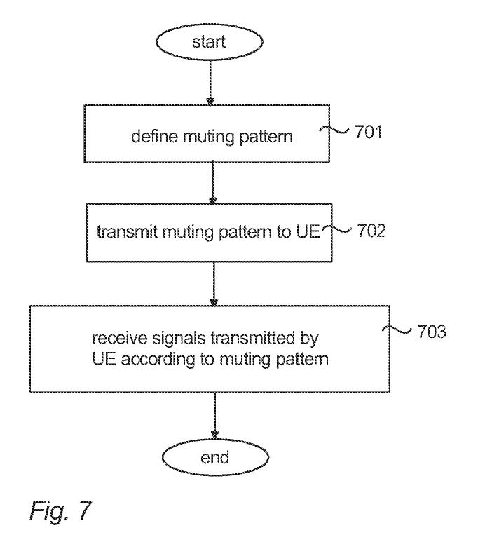

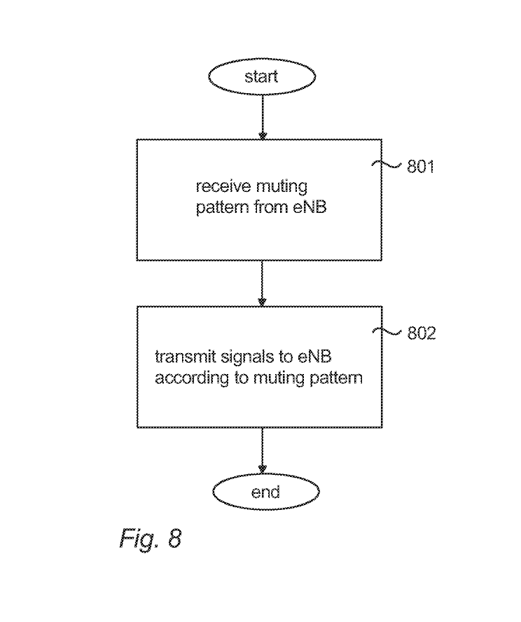

It should be noted that the GSM/LTE refarming as disclosed herein is only exemplary and the present solution is not limited to these radio network technologies or networks. Instead, the present solution is applicable to any radio network technology capable of utilizing a muting pattern. FIG. 7 is a flow chart illustrating an exemplary embodiment. The apparatus 401, which may comprise e.g. a base station (eNB), is configured to define, in 701, a multi-shot or single-shot muting pattern regarding uplink signals that are to be temporarily muted, the uplink signals comprising higher layer configured uplink signals that are outside the control of a dynamic scheduler of the network apparatus. The apparatus is configured to control one or more user terminals 402 to mute uplink signals according to said pattern, by transmitting, in 702, the defined muting pattern or a part of the pattern to the user equipment 402. In 703, the apparatus 401 is configured to receive, from the user equipment 402, signalling where selected higher layer configured uplink signals have been muted by the user equipment 402 according to (the part of) the muting pattern transmitted by the apparatus 401. FIG. 8 is a flow chart illustrating an exemplary embodiment. The user terminal (user equipment UE) 402 is configured to receive, in 801, a multi-shot or single-shot muting pattern (or a part of the muting pattern) regarding uplink signals that are to be temporarily muted, the uplink signals comprising higher layer configured uplink signals that are outside the control of a dynamic scheduler of a network apparatus 401. The user terminal 402 and applies (the part of) the muting pattern by muting higher layer configured uplink signals that are outside the control of a dynamic scheduler of the network apparatus, according to the muting pattern received from the network apparatus. Thus the user equipment 402 is configured to transmit, in 802, to the apparatus 401, signalling where selected higher layer configured uplink signals have been muted by the user equipment 402 according to (the part of) the muting pattern received from the apparatus 401.

Thus, according to an exemplary embodiment, there is provided a method comprising performing, in a network apparatus, the method steps of defining, in a network apparatus, a multi-shot or single-shot muting pattern regarding uplink signals that are to be temporarily muted, said uplink signals comprising higher layer configured uplink signals that are outside the control of a dynamic scheduler of the network apparatus, and signalling at least a part of the defined muting pattern from the network apparatus to at least one user equipment in order to control the at least one user equipment to mute said uplink signals according to said pattern. According to another exemplary embodiment, there is provided an apparatus configured to define a multi-shot or single-shot muting pattern regarding uplink signals that are to be temporarily muted, said uplink signals comprising higher layer configured uplink signals that are outside the control of a dynamic scheduler of the apparatus, and signal at least a part of the defined muting pattern to at least one user equipment in order to control the at least one user equipment to mute said uplink signals according to said pattern. According to yet another exemplary embodiment, there is provided a user equipment configured to receive, from a network apparatus, at least a part of a multi-shot or single-shot muting pattern regarding uplink signals that are to be temporarily muted, said uplink signals comprising higher layer configured uplink signals that are outside the control of a dynamic scheduler of the network apparatus, and mute higher layer configured uplink signals according to the pattern received from the network apparatus.

According to yet another exemplary embodiment, there is provided a communications system comprising an apparatus, wherein the system is configured to define, in the apparatus, a multi-shot or single-shot muting pattern regarding uplink signals that are to be temporarily muted, said uplink signals comprising higher layer configured uplink signals that are outside the control of a dynamic scheduler of the apparatus, and signal at least a part of the defined muting pattern from the apparatus to at least one user equipment in order to control the at least one user equipment to mute said uplink signals according to said pattern.

According to yet another exemplary embodiment, there is provided a computer-readable storage medium embodying a program of instructions executable by a processor to perform actions directed toward defining, in a network apparatus, a multi-shot or single-shot muting pattern regarding uplink signals that are to be temporarily muted, said uplink signals comprising higher layer configured uplink signals that are outside the control of a dynamic scheduler of the network apparatus, and signalling at least a part of the defined muting pattern from the network apparatus to at least one user equipment in order to control the at least one user equipment to mute said uplink signals according to said pattern. In yet another exemplary embodiment, the muting pattern is user equipment specific, cell specific, or network specific. In yet another exemplary embodiment, the apparatus is configured to convey information related to the muting pattern to a further network apparatus.

In yet another exemplary embodiment, the apparatus is configured to define the muting pattern for one or more cells, wherein the apparatus is configured to coordinate the muting pattern among multiple cells in a certain geographical area via standardized signalling with a further apparatus, or via a non-standardized operation and maintenance function O&M. In yet another exemplary embodiment, the apparatus is configured to define the muting pattern to be common for multiple cells corresponding to a same network layer.

In yet another exemplary embodiment, the apparatus is configured to trigger muting based on a specific muting physical downlink control channel including a cell-specific, user equipment specific or user equipment group specific temporary identifier.

In yet another exemplary embodiment, the cell-specific, user equipment specific, or user equipment group specific identifier indicates that the physical downlink control channel signals muting-related information.

In yet another exemplary embodiment, the apparatus is configured to identify a scheduled muting physical downlink control channel based on an identifier included on the physical downlink control channel.

In yet another exemplary embodiment, in order to maximize the coverage area of the muting physical downlink control channel without increasing the number of physical downlink control channel blind decoding in the user equipment, the apparatus is configured to utilize one of the smallest physical downlink control channel payload size options corresponding to downlink control information format 1C and/or 0/1A for the muting physical downlink control channel.

In yet another exemplary embodiment, the apparatus is configured to define the muting pattern including the duration of the muting via higher layer signalling, said higher layer signalling comprising dedicated radio resource control signalling or broadcast signalling.

In yet another exemplary embodiment, the apparatus is configured to define the muting pattern by means of payload bits of a muting physical downlink control channel.

In yet another exemplary embodiment, the apparatus is configured to pre-define, for the user equipment, a maximum processing time after which a muting command becomes valid.

In yet another exemplary embodiment, the apparatus is configured to set the maximum processing time to be 4 sub-frames. In yet another exemplary embodiment, the apparatus is configured to define scheduling such that that there is a fixed timing relationship between a received muting physical downlink control channel and an actual muting carried out in the user equipment.

In yet another exemplary embodiment, the apparatus is configured to define possible starting positions for the muting via higher layers using dedicated radio resource control signalling or broadcast signalling.

In yet another exemplary embodiment, the apparatus is configured to receive signalling from the user equipment, wherein selected higher layer configured uplink signals have been muted by the user equipment according to the muting pattern transmitted by the apparatus.

In yet another exemplary embodiment, the user equipment is configured to mute said signals by dropping higher-layer configured uplink transmission according to the muting pattern. In yet another exemplary embodiment, the user equipment is configured to mute said signals by reducing transmission power for the higher-layer configured uplink transmission according to the muting pattern and according to a predefined transmission power offset.

In yet another exemplary embodiment, the user equipment is configured to mute said signals in a frequency selective manner such that the muting is restricted on a selected uplink frequency portion of a system bandwidth, or such that the muting follows a GSM uplink frequency hopping pattern. It will be obvious to a person skilled in the art that, as the technology advances, the inventive concept may be implemented in various ways. The invention and its embodiments are not limited to the examples described above but different combinations of the embodiments are possible.

### List of Abbreviations

ACK acknowledgement
AMR adaptive multi-rate
CQI channel quality indicator
CRS common reference signal
CSI channel state information
DCI downlink control information
eICIC enhanced inter-cell interference coordination
ICIC inter-cell interference coordination
eNB enhanced node B
ETSI European telecommunications standards institute
GSM global system for mobile communications
UMTS universal mobile telecommunications system
EDGE enhanced data rates for global evolution
WCDMA wideband code division multiple access
WLAN wireless local area network
SR scheduling request
GPS global positioning system
HetNet heterogeneous network
ISM industrial, scientific and medical
LTE long term evolution
MBSFN multi-media broadcast over a single frequency network
NACK negative ACK
OTAC over the air communications
PDCCH physical downlink control channel
PDSCH physical downlink shared channel
PRACH physical random access channel
PUCCH physical uplink control channel
PUSCH physical uplink shared channel
O&M operation and maintenance
RAT radio access technology
RRC radio resource control
RRM radio resource management
SACCH slow associated control channel
TDMA time division multiple access
UE user equipment
UL uplink
X2 interface for interconnection of two E-UTRAN node
Bs
RAN radio access network
MIB management information base
SIB system information block
RNTI radio network temporary identifier
CRC cyclic redundancy check

1-37. (canceled)

38. A method of controlling of radio resource usage in a communications system, the method comprising
defining, in a network apparatus, a multi-shot or single-shot muting pattern regarding uplink signals that are to be temporarily muted, said uplink signals comprising higher layer configured uplink signals that are outside the control of a dynamic scheduler of the network apparatus; and
signalling at least a part of the defined muting pattern from the network apparatus to at least one user equipment in order to control the at least one user equipment to mute said uplink signals according to the signalled pattern.

39. An apparatus configured to
define a multi-shot or single-shot muting pattern regarding uplink signals that are to be temporarily muted, said uplink signals comprising higher layer configured uplink signals that are outside the control of a dynamic scheduler of the apparatus; and
signal at least a part of the defined muting pattern to at least one user equipment in order to control the at least one user equipment to mute said uplink signals according to the signalled pattern.

40. An apparatus according to claim 39, wherein the muting pattern is user equipment specific, cell specific, or network specific.

41. An apparatus according to claim 39, wherein the apparatus is configured to convey information related to the muting pattern to a further network apparatus.

42. An apparatus according to claim 39, wherein the apparatus is configured to define the muting pattern for one or more cells, wherein the apparatus is configured to coordinate the muting pattern among multiple cells in a certain geographical area via standardized signalling with a further apparatus, or via a non-standardized operation and maintenance function O&M.

43. An apparatus according to claim 39, wherein the apparatus is configured to define the muting pattern to be common for multiple cells corresponding to a same network layer.

44. An apparatus according to claim 39, wherein the apparatus is configured to trigger muting based on a specific muting physical downlink control channel including a cell-specific, user equipment specific or user equipment group specific identifier.

45. A user equipment configured to
receive, from a network apparatus, at least a part of a multi-shot or single-shot muting pattern regarding uplink signals that are to be temporarily muted, said uplink signals comprising higher layer configured uplink signals that are outside the control of a dynamic scheduler of the network apparatus; and
mute higher layer configured uplink signals according to the pattern received from the network apparatus.

46. A user equipment according to claim 45, wherein the user equipment is configured to mute said signals by dropping higher-layer configured uplink transmission according to the received pattern.

47. A user equipment according to claim 45, wherein the user equipment is configured to mute said signals by reducing transmission power for the higher-layer configured uplink transmission according to the muting pattern and according to a predefined transmission power offset.

48. A user equipment according to claim 45, wherein the user equipment is configured to mute said signals in a frequency selective manner such that the muting is restricted on a selected uplink frequency portion of a system bandwidth, or such that the muting follows a frequency hopping pattern.

49. A user equipment according to claim 45, wherein it is configured to trigger the muting based on receiving a specific muting physical downlink control channel including a cell-specific, user equipment specific, or user equipment group specific identifier.

50. A user equipment according to claim 45, wherein it is configured to receive the muting pattern including the duration of the muting via higher layer signalling, said higher layer signalling comprising dedicated radio resource control signalling or broadcast signalling.

51. A user equipment according to claim 45, wherein it is configured to receive the muting pattern by means of payload bits of a muting physical downlink control channel.

52. A user equipment according to claim 45, wherein it is configured to receive a pre-definition of a maximum processing time after which the muting command becomes valid.

53. A user equipment according to claim 45, wherein it is configured to carry out the actual muting such that that there is a fixed timing relationship between a received muting physical downlink control channel and the actual muting.

54. A user equipment according to claim 45, wherein it is configured to receive possible starting positions for the muting via higher layers using dedicated radio resource control signalling or broadcast signalling.

55. A communications system comprising an apparatus, wherein the system is configured to
define, in the apparatus, a multi-shot or single-shot muting pattern regarding uplink signals that are to be temporarily muted, said uplink signals comprising higher layer configured uplink signals that are outside the control of a dynamic scheduler of the apparatus; and
signal at least a part of the defined muting pattern from the apparatus to at least one user equipment in order to control the at least one user equipment to mute said uplink signals according to the signalled pattern.

56. A computer-readable storage medium embodying a program of instructions executable by a processor to perform actions directed toward
defining, in a network apparatus, a multi-shot or single-shot muting pattern regarding uplink signals that are to be temporarily muted, said uplink signals comprising higher layer configured uplink signals that are outside the control of a dynamic scheduler of the network apparatus; and
signalling at least a part of the defined muting pattern from the network apparatus to at least one user equipment in order to control the at least one user equipment to mute said uplink signals according to the signalled pattern.
